(19) United States
(12) Patent Application Publication
(10) Pub. No.: US 2020/0245667 A1
(43) Pub. Date: Aug. 6, 2020

(54) OLIGOSACCHARIDE COMPOSITIONS AND THEIR USE DURING TRANSITIONAL PHASES OF THE MAMMALIAN GUT MICROBIOME

(71) Applicant: EVOLVE BIOSYSTEMS, INC., Davis, CA (US)

(72) Inventors: Giorgio CASABURI, Davis, CA (US); Steven FRESE, Davis, CA (US); David KYLE, Davis, CA (US); Samara FREEMAN-SHARKEY, Davis, CA (US)

(21) Appl. No.: 16/646,628

(22) PCT Filed: Sep. 13, 2018
(86) PCT No.: PCT/US2018/050971

§ 371 Date: Mar. 12, 2020

Related U.S. Application Data
(60) Provisional application No. 62/558,344, filed on Sep. 13, 2017.

(51) Int. Cl. A23L 33/125; A23K 10/14; A23K 10/30; A23K 20/163; A23K 10/18; A23K 50/20; A23K 50/30; A23K 50/60; A23L 33/00; A23L 33/21; A23L 33/135

(52) U.S. Cl. CPC A23L 33/125; A23Y 2300/55; A23K 10/30; A23K 20/163; A23K 10/18; A23K 50/20; A23K 50/30; A23K 50/60; A23L 33/40; A23L 33/21; A23L 33/135; A23V 2002/00; A23Y 2220/71; A23Y 2300/45; A23Y 2220/67; A23K 10/14

(57) ABSTRACT

This invention provides compositions of oligosaccharides, their preparation, and their use to facilitate the growth of certain beneficial gut bacteria over other gut bacteria in a mammal in order to prevent gastrointestinal distress associated with a major change in gut microflora, such as that which occurs when an infant is weaned from its mother's milk to alternative food sources, or during the recovery of the gut microbiome after a course of oral antibiotics, hospitalization, therapy such as chemotherapy or radiation treatments, or conditions where a deficiency in dietary fiber is observed. Novel compositions of oligosaccharides, oligosaccharides and bacteria, foods comprising those compositions, and methods of preparation and use of those compositions are described.

### FIELD OF INVENTION

The inventions described herein relate generally to compositions of oligosaccharides, their preparation, and their use to facilitate the growth of certain beneficial gut bacteria over other gut bacteria in a mammal in order to prevent gastrointestinal distress associated with a major change in gut microflora such as that which occurs when an infant is weaned from its mother's milk to alternative food sources, or during the recovery of the gut microbiome after a course of oral antibiotics, hospitalization, therapy such as chemotherapy or radiation treatments, or conditions where a deficiency in dietary fiber is observed. Novel compositions of oligosaccharides, oligosaccharides and bacteria, foods comprising those compositions, and methods of preparation and use of those compositions are described.

### BACKGROUND

Weaning represents a change from a sole source of nutrition (mother's milk) to more diverse sources of nutrition (complimentary foods). New dietary fiber in the diet has a major effect on the microbiome because dietary fiber is generally digested by gut microflora, and different plant fibers provide environmental pressure that will facilitate the growth of different microbes. A nursing mammal transitioning from an exclusive milk oligosaccharide diet to a diet that includes many different plant-based polysaccharides will have a constantly changing microbiome as different enzymatic capabilities (i.e., different microbes) will be favored by different polysaccharides. It is common when introducing a new food to a nursing mammal that the underlying microorganisms, which may make up the minority portion of the microbiome suddenly have the potential to rapidly expand (a microbial bloom). These changes have been characterized in non-human mammals such as swine by Frese et al (Microbiome. 2015; 3: 28.), and bovine by Meale (Scientific Reports 7, Article number: 198; 2017). Human infants often have symptoms of diarrhea, reflux, and colic during weaning to complementary foods. DeWeerth et al (Pediatrics 2013; 131:e550-e558) have shown that certain microbiota in the infant gut (the proteobacteria, especially Escherichia, Klebsiella, Serratia, Vibrio, Yersinia, and Pseudomonas) are associated with colic.

After the first few weeks of life, the breast-fed infant has a remarkably stable microbiome, as the source of oligosaccharide (breast milk) is unchanged for many months. However, as this source of oligosaccharides is replaced by new plant-based sources of fiber (polysaccharides), new ecological niches are opened that can quickly be filled by blooms of Proteobacteria. The resulting gas production can quickly result in symptoms such as colic, reflux, and diarrhea. Although this shift in the microbiome is a consequence of the introduction or re-introduction of foods to an individual's diet, the art presently has no way to control the subsequent outcome or check that those microbes are present which deal effectively with that ingredient and/or food.

The non-infant mammalian microbiome contains a complexity and diversity of species of bacteria, which develops only after the cessation of milk consumption as a sole source of nutrition. Conventional teaching with regards to the non-infant mammalian microbiome is that complexity provides stability. To be able to effectively consume the complex non-infant diet, maintaining a diversity of microorganisms in the microbiome is thought to be the key to promoting gut health. Lozupone, Nature, Vol. 489, pp. 220-230 (2012).

Treatment of any animal, including all mammals, with antibiotics has an immediate effect of altering the absolute amount and complexity of that animal's microbiome. At the cessation of the course of antibiotic treatment, the rebuilding of the microbiome may be affected by the food being eaten by that mammal and the presence of, or inoculation with, specific bacteria in the intestine. Similar wholesale changes in the microbiome are seen with the use of many chemotherapeutic drugs and therapies, such as fecal microbial transplants.

The transition from a lower diversity unstable, dysbiotic intestinal ecosystem (caused by the use of antibiotics, chemotherapeutic drugs, a change in diet, blooms of pathogenic bacteria, or the like) and the subsequent re-establishment of a complex microbiome of the gastrointestinal tract (GI tract) is a major medical and physiological challenge. This transition often results in the sporadic and damaging proliferation of normally minor bacteria, termed ‘local blooms’ including specific strains of bacteria such as Salmonella, E. coli, Enterobacteria, and Clostridium spp. These blooms of bacteria are in turn detrimental themselves to the host by causing inflammation and direct damage to mucosal cells of the GI tract (Stecher et al 2013). Such bacterial blooms in mammals, depending on the nature of the strains involved, can be reflected in symptoms such as colitis, diarrhea, colic and scours and, under some circumstances, may lead to necrosis, sepsis, and even death.

The inventors have discovered that one cause of the bacterial blooms responsible for inflammation and dysbiosis that occur in the microbiome transitional stages is the direct result of the combination of indigestible components (“dietary fiber”) of specific foods consumed by the ‘host’ that reach the large intestine and the pattern by which those food components are broken down by commensal and opportunistic bacteria present in the host's GI tract. Moreover, the inventors have discovered that a critical mechanism underlying these microbial blooms, inflammation, and the resulting dysbiosis, is the breakdown and incomplete absorption of the complex undigested carbohydrates, proteins and peptides by resident colonic bacteria, resulting in the release of large amounts of Free Sugar Monomers (FSMs), Free Amino Acids (FAA's) and small peptides. Access to FSMs, FAA's, and peptides released into the large intestine become an enabling food source which opportunistic bacteria use as a growth substrate. This represents a mismatch between the diet and the bacteria that use those substrates. Not all bacteria in the gut are equal; they have different potentials to use and survive in a complex intestinal nutrient environment. The inventors have discovered that there are better choices for pairing bacteria and dietary fibers during weaning (transitions between new states) to minimize access to any free sugars released as a result of gut activities and any subsequent pathology.

### SUMMARY OF INVENTION

Creating a healthy intestinal microbiome is important for the overall health of any mammal. Dramatic changes in the microbiome occur at a number of times throughout the lifespan. These changes start at birth with the initial colonization of the infant gut with a microbiome that is nutritionally directed by the human milk oligosaccharides. The next major change occurs at the time of weaning when new types of polysaccharides are introduced into the diet. Anytime the individual takes a course of antibiotics, or suffers GI distress, the microbiome may be again restructured. Finally, in the geriatric years of life the gut microbiome again changes in response to changes in the diet that accompany changes in lifestyle or institutional living. Each of these changes are accompanied by disruptions due to new bacterial species blooming in the gut as the result of the opening of new ecological niches created by changes in the diet. The inventors have discovered a way to allow these gut microbiome changes to occur without dramatically opening ecological niches that would allow certain Proteobacteria to bloom, and thereby allow the transitions to take place in the absence of serious side effects such as diarrhea, reflux, or colic.

The gut microbiome operates on a principle of cross-feeding between different microbes (i.e., a microbial food chain). In the case of the breast-fed baby getting human milk as the sole-source of nutrition, the dietary fiber feeding the gut microbiome consists of an array of human milk oligosaccharides (HMOs), most of which with degrees of polymerization (DP) ranging from 3-10. Bifidobacteria longum subsp infantis (B. infantis) has evolved to be particularly successful at consuming these HMOs due to two important attributes: 1) it has the capability of transporting the HMOs from the outside of the cell to the inside of the cell (i.e., it is an “inside eater”); and 2) it contains all the genes for all the enzymes to totally deconstruct all the different glycosidic bonds in the HMO structures (about 9 different enzymes). As this organism is unique in having these attributes, it dominates the microbiome of breast-fed infant. However, its disadvantage is that it can only transport oligosaccharides (specifically HMOs) into the cell that are quite small (i.e., DP 3-10) and as plant polysaccharides are much larger (DP11 and larger), B. infantis, is unable to consume them. Other gut bacteria excrete extracellular hydrolases and do not internalize oligosaccharide structures. These can be both endo-hydrolases (cleaving polysaccharides at specific bonds in the middle of the molecule) and exo-hydrolases (cleaving monomeric sugars from the ends of the polysaccharides). Therefore, as the breast-fed infant weans from fiber dominated by HMOs to complimentary foods whose fiber component is dominated by large plant polysaccharides, there is a rapid and dramatic change in the gut microbiome by the loss of one major nutritional niche for HMO consumers and the appearance of another major nutritional niche (polysaccharide consumers) and consumers of other sugars both monomers and oligomers not found in human milk (i.e., arabinose, xylose, rhamanose).

Through metagenomic analysis of the gut of a breast-fed infant in the process of weaning, the inventors have established which glycosyl hydrolase gene families are present, and to which species they belong. They discovered that there were several endo-hydrolases belonging to Bacteroidetes that would cleave different plant polymers, such as those found in rice or wheat bran, pectin or capsicum, into shorter oligosaccharide subunits. This suggested that the resulting oligosaccharides could potentially cross-feed other preferred microbiota that could deconstruct extracellular poly- and oligosaccharides with exo-hydrolases effectively reducing the occurrence of the other less desirable microbes.

In one mode, this invention provides compositions comprising oligosaccharides where over 50%, over 60%, over 70%, over 80%, or over 90% of the oligosaccharides have DP3-DP10, these oligosaccharides being prepared by: (a) incubating one or more plant polysaccharides with one or more endoglucanases; (b) removing the monomers, dimers and/or oligomers with DP>10 from the oligosaccharides; and (c) drying the final oligosaccharide product. The endoglucanases may be chosen from glycoside hydrolase (GH) families GH5, GH13, GH18, GH28, GH29, GH43, GH92, and GH95. Separation of the monomers, dimers, and polymers >DP10 from the oligosaccharides in step (b) may be accomplished by filtration and/or through incubation with live yeast. The plant polysaccharides may come from carrots, peas, broccoli, onions, tomato, pepper, rice, wheat, or bran. In some embodiments, a chitin or chitosan polymer may be substituted for the plant polysaccharides. For example, chitin or chitosan polymers may be extracted from mushrooms.

In another mode, this invention provides oligosaccharide compositions comprising over 50%, over 60%, over 70%, over 80%, or over 90% oligosaccharides having degree of polymerization from DP3-DP10, where the oligosaccharides are prepared by: (a) incubating one or more plant polysaccharides with a thermostable ionic liquid solvent with or without a catalyst; (b) stopping the reaction by the addition of an equal volume of water into which the monomers, dimers, and oligosaccharides will dissolve; (c) removing the monomers, dimers and/or oligomers with DP>10 from the oligosaccharides; and (d) drying the final oligosaccharide product. In preferred embodiments, the ionic liquid solvent is selected from the group consisting of 1-ethyl-3-methylimidazolium acetate ([EMIM]AcO), 1-allyl-3-methylimidazolium chloride ([AMIM]Cl), 1-butyl-3-methylimidazolium chloride ([BMIM]Cl) and dialkylimidazolium dialkylphosphates, where the ionic liquid solvent optionally contains an ionic solvent tolerant glycoside hydrolase. Separation of the monomers, dimers, and polymers >DP10 from the oligosaccharides in step (b) may be accomplished by filtration and/or through incubation with live yeast. The plant polysaccharides may come from carrots, peas, broccoli, onions, tomato, pepper, rice, wheat, or bran.

In yet another mode, this invention provides oligosaccharide compositions comprising over 50%, over 60%, over 70%, over 80%, or over 90% oligosaccharides having degree of polymerization from DP3-DP10, where the oligosaccharides are prepared by: (a) incubating one or more plant polysaccharides with a concentrated acid; (b) quenching the reaction by neutralizing the acid with a strong base; (c) removing the monomers, dimers and/or oligomers with DP>10 from the oligosaccharides; and (d) drying the final oligosaccharide product. In preferred embodiments, the strong acid is sulfuric, hydrochloric, uric, or, triflouroacetic, and the strong base is sodium or potassium hydroxide. Separation of the monomers, dimers, and polymers >DP10 from the oligosaccharides in step (b) may be accomplished by filtration and/or through incubation with live yeast. The plant polysaccharides may come from carrots, peas, mushrooms, broccoli, onions, tomato, pepper, rice, wheat, or bran. In some embodiments, a chitin or chitosan polymer may be substituted for the plant polysaccharides. For example, chitin or chitosan polymers may be extracted from mushrooms.

In still another mode, this invention provides oligosaccharide compositions comprising over 50%, over 60%, over 70%, over 80%, or over 90% oligosaccharides having degree of polymerization from DP3-DP10, where the oligosaccharides are prepared by: (a) incubating one or more glycosylated protein with an N-linked and/or O-linked glycosyl hydrolases; (b) separating the deglycosylated protein from the glycans; (c) incubating the glycans with one or more endoglucanases; (d) removing the monomers, dimers and/or oligomers with DP>10 from the oligosaccharides; and (e) drying the final oligosaccharide product. In preferred embodiments, the N-linked glycosyl hydrolase is Endo B1 from B. infantis. In other embodiments an O-linked glycosyl hydrolase is used. Separation of the monomers, dimers, and polymers >DP10 from the oligosaccharides in step (b) may be accomplished by filtration and/or through incubation with live yeast. The glycosylated protein may come from a plant, algal, fungal or bacterial source, or the glycosylated protein may come from an animal source.

In yet another mode, this invention provides oligosaccharide compositions comprising over 50%, over 60%, over 70%, over 80%, or over 90% oligosaccharides having degree of polymerization from DP3-DP10, where the oligosaccharides are prepared by: (a) subjecting one or more plant polysaccharides to a combination of physical stress including one or more of heat, sonication and pressure; (b) removing the monomers, dimers and/or oligomers with DP>10 from the oligosaccharides; and (c) drying the final oligosaccharide product.

This invention also provides a composition comprising: (a) non-milk oligosaccharides wherein 50% 60%, 70%, 80% or 90% of the oligosaccharides are DP3-DP10; and (b) one or more commensal bacteria capable of consuming the oligosaccharide fragments of plant-derived polysaccharide. Generally, the commensal bacteria is one or more species of bifidobacteria, lactobacilli, and pediococci. In preferred embodiments, the bifidobacteria is one or more of B. breve, B. longum subsp. infantis, B. longum subsp. longum and B. adolescent; the lactobacilli is one or more of L. plantarum, L. reuteri, and L. casei; and the pediococci is one or both of P. clausseni and P. acidilacti. In particularly preferred embodiments, the oligosaccharide comprises arabinose and rhamnose residues and the bacteria comprises Lactobacillis reuteri and/or Bacteriodetes sp.

In other embodiments, this invention provides baby food wherein at least 20%, at least 40%, at least 60%, at least 80%, at least 95% of the total fiber in the baby food is from plant-derived oligosaccharides. Preferably, the plant-based oligosaccharides are predominantly between 1 and 10 sugar residues (DP1-DP10), between 3 and 10 sugar residues (DP3-DP10), or between 5 and 10 sugar residues (DP5-DP10). In some embodiments, the baby food also contains polysaccharides greater than DP30.

In still other embodiments, this invention provides a food composition for a geriatric individual wherein at least 20%, at least 40%, at least 60%, at least 80%, at least 95% of the fiber is in the form of plant-based oligosaccharides. Preferably, the plant-based oligosaccharides are predominantly between 1 and 10 sugar residues (DP1-DP10), between 3 and 10 sugar residues (DP3-DP10), or between 5 and 10 residues (DP5-DP10). The stability of the microbiome can be promoted in the geriatric individual by administering the food composition described herein.

In yet other embodiments, gut health in an individual can be promote by including any of the composition described herein in a human diet. The composition can be consumed contemporaneously with probiotic Bifidobacteria. The bifidobacteria can be B. longum subsp. longum, B longum subsp. infantis or B. breve.

In some embodiments, a polysaccharide-containing food can be improved by predigesting the food with a digestive agent. The digestive agent can include glycosyl hydrolases; and/or (b) a microbe expressing the glycosyl hydrolase(s). The glycosyl hydrolases can include GHs selected from GH5, GH13, GH43, and/or GH92.

In yet other embodiments, microbiome development can be facilitated during weaning by administering a diet which includes arabinose-containing polysaccharide, while GH43-containing Bacteriodetes sp. is administered contemporaneously. Additionally, lactobacillus may be added contemporaneously. The lactobacillus may be Lactobacillus reuteri, L. plantarum, L. casei, and/or L. equi.

In some embodiments, microbiome development may be facilitated during weaning by administering a diet which includes pectin-containing vegetables. GH28-containing bacteria may administered contemporaneously.

In still other embodiments, any of the compositions described herein may be included in an infant formula. The composition may be provided in a ready-to-feed formulation at a level of from 2-10 g/L.

### DETAILED DESCRIPTION OF THE INVENTION

### Definitions

Free sugar monomers (FSM) may be released from the intact dietary fibers of different food sources in the colon by the action of colonic microbes. These dietary fibers are generally broken down into FSMs by the action of extracellular enzymes produced by various colonic microbes, but these microbes may or may not have the ability to utilize all of the FSMs produced by this enzymatic digestion of the complex oligosaccharides. Indeed, the inventors have discovered that different types of commensal and pathogenic bacteria in the lower GI tract, and particularly in the colon, have different and specific abilities to import and metabolize these FSMs to provide cellular energy. Finally, the inventors have discovered that, by providing specific commensal bacteria as probiotics to an individual who is adding a new source of dietary fiber to their diet, one can minimize the risk of producing blooms of pathogenic microbes that can lead to gut pain, discomfort, or changes in fecal transit times. One mechanism is through controlling the access to FSMs.

The term “mammalian milk oligosaccharide” (MMO), as used herein, refers to those indigestible glycans, sometimes referred to as “dietary fiber”, or the carbohydrate polymers which are not hydrolyzed by the host endogenous enzymes in the digestive tract and remain unabsorbed in the intestinal lumen (e.g., the stomach or small intestine) and reach the large intestine where they may be digested by the microbiome of the mammal.

Non-milk food according to this invention, if it contains any dietary fiber, does not provide MMO as the majority of the dietary fiber. Infant formula as marketed today would be considered a non-milk food for the purposes of this invention, since it does not include MMO. Preferably, a non-milk food composition of this invention contributes a controlled portion of dietary fiber to adapt to the bacterial culture. For example, the non-milk food can contribute about 50%, less than 50%, less than 40%, less than 30%, less than 20%, less than 15%, less than 10%, less than 5%, less than 2.5%, less than 1%, less than 0.5% by weight of the total dietary fiber in the diet, depending on the phase of weaning. In some embodiments, the non-milk food can contribute more than 50%, more than 55%, more than 60%, more than 70%, more than 75%, more than 80%, more than 85%, more than 90%, more than 95%, more than 99% of the dietary fiber by weight in a controlled diet composition. Fiber is described herein in grams and their percentages are described herein as percent by weight.

In typical embodiments of the instant invention, non-milk oligosaccharide compound(s) can be included in a weaning food composition. The food composition can comprise non-milk nutritional components for an infant mammal including, but not limited to, applesauce, avocado, banana, squash, carrots, green beans, oatmeal, peaches, pears, peas, potatoes, cereal, sweet potatoes, meat, and fish in natural or pureed form, alone or in combination with each other, and MMO.

A number of weaning foods are provided in Table 1, showing where the inventors have determined the most likely FSMs that are released by the partial digestive degradation of their component oligosaccharides. Such FSMs include, but are not limited to, sialic acid, fucose, rhamnose, mannose, glucose, gluconate, glucuronic acid, galacturonic acid, arabinose, fructose, xylose, N-acetyl glucosamine, N-acetylgalactosamine, and N-glycoyl-neuraminic acid.

A number of bacterial species are provided in Table 2, since the inventors have discovered preferred carbon source(s) for certain bacteria. Certain embodiments of the invention described herein would include one or more of any of the species found in Table 2.

A “controlled diet” according to this invention provides a composition comprising a non-milk food and MMO, and the MMO may be from a human, bovine, equine, or caprine source, or may be from another source that provides oligosaccharides having the same function and similar structure. Such compositions may be administered for a period to accommodate progressive change in the microbiome, with or without concurrent administration of probiotic bacteria. In a typical embodiment of this invention, the mammal has a microbiome in need of increasing its complexity by at least 10%, preferably by at least 20%, more preferably by at least 30% of the total bacterial species present in the gut.

The phrase “increase complexity” when used herein means increasing the complexity based on taxonomic classification of the bacteria in the microbiome of the mammal, and/or increasing the complexity based on the proportional number of bacteria by classification in the microbiome of the mammal, which may be generally calculated from the amount of DNA with sequences specific to a particular genus, species, or strain normalized against the total amount of DNA sequences in stool.

Glycoside hydrolase or Glycosyl hydrolase (GH) are a widespread group of enzymes which hydrolyse the glycosidic bond between two or more carbohydrates or between a carbohydrate and a non-carbohydrate moiety. They are classified into families with numerical designations (www.cazy.org/Glycoside-Hydrolases.html). Endoglucanases are any glucanase/cellulase that cleaves internal glycoside bonds in a glucose polymer, as opposed to clipping off a terminal glucose from one end of a polymeric chain.

### Oligosaccharides

Mammalian milk contain a significant quantity of mammalian milk oligosaccharides (designated herein as “MMOs”) in a form that is not usable as an energy source for the milk-fed mammal. MMOs are also not digestible by most of the microorganisms in the gut of that mammal. MMOs can be found as free oligosaccharides (soluble fiber) or conjugated to protein or lipids (“dietary glycans”). The term “mammalian milk oligosaccharide”, as used herein, includes those indigestible oligosaccharides and glycans, sometimes referred to as “dietary fiber”, or the carbohydrate polymers which are not hydrolyzed by the endogenous enzymes in the digestive tract (e.g., the small intestine) of the mammal. Oligosaccharides having the chemical structure of the indigestible oligosaccharides found in any mammalian milk are collectively called “MMO” or “mammalian milk oligosaccharides” herein, whether or not they are actually sourced from mammalian milk.

For human milk oligosaccharides (“HMOs”), the major HMOs in milk include lacto-N-tetraose (LNT), lacto-N-neotetraose (LNnT) and lacto-N-hexaose, which are neutral HMOs, in addition to fucosylated oligosaccharides such as 2-fucosyllactose (2FL), 3-fucosyllactose (3FL), difucosyllactose, and lacto-N-fucopentaoses I, II, III, and V. Acidic HMOs include sialyl-lacto-N-tetraose (SLNT), 3′ and 6′ sialyllactose (6SL), and 3′-sialyllactosamine, (3SL), 6′-sialyllactosamine, and 3′-sialyl-3-fucosyllactose. HMOs are particularly highly enriched in fucosylated oligosaccharides (U.S. Pat. No. 8,197,872). Among the enzymes that produce HMOs in the mammary gland is the enzyme encoded by the 2-fucosyltransferase (FUT2) gene, which catalyzes the linking of fucose residues by an α1,2-linkage to oligosaccharides found in human milk. Fucosylated oligosaccharides are known to inhibit the binding of pathogenic bacteria in the gut. HMOs, and in particular the fucosylated HMOs, share common structural motifs with glycans on the infant's intestinal epithelia known to be receptors for pathogens. (German et al., WO 2012/009315).

In a preferred embodiment of the invention, the MMO includes, but is not limited to, human milk oligosaccharides (HMO), bovine milk oligosaccharides (BMO), bovine colostrum oligosaccharides (BCO), and goat milk oligosaccharides (GMO), or any single purified MMO or any combination thereof. Preparation methods for such compositions are described, for example, in U.S. Pat. Nos. 8,197,872 and 9,200,091, and International Publication No. WO 2016/065324, the disclosures of which are incorporated herein by reference in their entirety. In typical embodiments, the MMO of the food composition is present in an amount of from about 10 to 5,000 mg/oz of food. In a more preferred embodiment, the MMO is present in an amount of from 50-1,000 mg/oz of food. In a particularly preferred embodiment, the MMO is present in an amount of from 100-500 mg/oz of food. In an alternative embodiment, the MMO may comprise dietary or soluble fiber oligosaccharides from milk of more than one species of mammal or can be produced from sources other than milk. In another preferred embodiment, the MMO may be substituted by oligosaccharides from sources other than milk, including but not limited to MMO produced by recombinant bacterial or chemical processes and/or galactooligosaccharide (GOS) preparations that provide selective growth of certain bifidobacteria such as B. longum subsp, infantis and B. breve as described in U.S. Pat. No. 8,425,930, the contents of which is incorporated herein by reference.

Plant based polysaccharides can be used in the instant invention, if they are first modified to produce a number of different oligosaccharides that closely resemble the majority of HMOs in size (DP 3-10). As such, they can then be used to promote the growth of more beneficial microorganisms such as bifidobacteria, lactobacilli and/or pediococci.

Plant-based polysaccharides may come from any conventional or functional foods, such as, but limited to, carrots, peas, onions, and broccoli. Polysaccharides may also come from food processing waste streams including shells, husks, rinds, leaves and clippings from vegetables, fruits, beans and tubers, such as, but not limited to, orange peels, onion hulls, cocao hulls, applecake, grape pomace, pea pods, olive pomace, tomato skins, sugar beets (Mueller-Maatsch et al, Food Chemistry. 2016. 201: 37-45). Sugar beet has 131-3 and 131-4 D-glucan (Serena & Knudsen. Animal Feed Science and Technology. 2007. Pages 109-124. In some embodiments, a chitin or chitosan polymer may be substituted for the plant polysaccharides. For example, chitin or chitosan polymers may be extracted from mushrooms.

They may also come from algae or yeast extracts. The polysaccharide may be part of a mixed food product or a purified polysaccharide fraction. The polysaccharide may be soluble fiber. The polysaccharide may be pre-treated physically, chemically, enzymatically, biologically, with inorganic catalysts, by fermentation, and/or with ionic fluids to convert insoluble fiber to soluble fiber.

The plant-based oligosaccharide composition of this invention can be products produced by enzymatic digestion of the polysaccharide. In some embodiments, the polysaccharides are predigested in a controlled fermentation. In some embodiments, the enzyme is cloned, purified and/or immobilized in a process for throughput of the polysaccharide. The released oligosaccharides may by purified or not from the polysaccharide or other components in the food matrix. In some embodiments, the cloned enzyme may be expressed in E. coli or yeast or other suitable organisms such as Bacillus to produce the desired oligosaccharides from the polysaccharide substrate. In some embodiments, an organism containing genes coding for enzymes such as, but not limited to, GH5, GH43, GH13, GH92 are used in a fermentation designed to produce new oligosaccharide. In some embodiments, cellulose is included in the formulation to maintain a certain percentage of insoluble fiber for appropriate bulk and water properties of fecal matter.

In some embodiments, one pot enzymatic reactions are used with multiple endo- and exohydrolases to produce new compositions of oligosaccharides from polysaccharides.

The plant-based oligosaccharide composition of this invention can be produced by chemical breakdown of the polysaccharides by conventional hydrolysis using strong acids such as, but not limited to sulfuric, hydrochloric, uric, and triflouroacetic, under elevated temperatures, followed by neutralization with a strong base such as, but not limited to, NaOH or KOH, and separation and drying of the final oligosaccharides. Inorganic catalysts such as small molecules or mineral ions may be used to reduce chain length or modify oligosaccharide structures (e.g., NaCl, KCl, MgCl₂, CaCl₂), Ca(OH)₂, Ca(NO₃)₂, CaCO₃, or CaHPO₄). The polysaccharides can also be hydrolyzed by exposing the polysaccharides to a catalyst (ionic solvent tolerant enzyme) that selectively cuts glycosidic bonds, in ionic liquid solvents with high thermal stability, low flammability and very low volatility including, but not limited to 1-ethyl-3-methylimidazolium acetate ([EMIM]AcO), 1-allyl-3-methylimidazolium chloride ([AMIM]Cl), 1-butyl-3-methylimidazolium chloride ([BMIM]Cl) and dialkylimidazolium dialkylphosphates (Wahlstrum and Suurankki (2015) Green Chem 17:694). An alternative acid ionic liquid (sulfuric acid and 1-(1-butylsulfonic)-3-methylimidazolium hydrosulfate) has been shown to efficiently hydrolyze polysaccharides in situ at only 100° C. (Satrai, et al, Sustainable Chem. Eng., 2017, 5 (1), pp 708-713) and can also be used in this invention. Oligosaccharides are then removed from the reaction mixture by the addition of water which forms a phase separation with the ionic fluid. In both cases, the reaction is stopped when the predominant oligosaccharide chain length is from DP 3-10.

The plant-based oligosaccharide composition of this invention can alternatively be produced by sonication, and/or heating and/or disruption under pressure to produce oligosaccharide chain length is from DP3-10.

In other embodiments, a combination of one or more techniques to break polysaccharides may be used to create a new product which has a composition that may be defined by LC/MS or other techniques. In further embodiments, the new pool of oligosaccharides of defined chain length are evaluated for their ability to grow specific selected species and/or their lack of ability to promote growth of other organisms.

Glycans attached to proteins from any source (plant, animal or microbial) can be released by an enzymatic process using N-linked and/or O-linked hydrolases and used as a starting point for this invention. Such structures are found in the carbohydrate components of certain plant and animal glycoproteins. These carbohydrates may be longer than desired DP and would be classified as polysaccharides. The inventors have also discovered that when these longer glycans are released from their constituent proteins, they too can be used in the instant invention.

Arabinoxylan is an example of a hemicellulose—a polysaccharide containing arabinose and xylose. Chitin and chitosan are examples of polysaccharides that are inaccessible, but can provide a valuable monomer—N-acetylglucosamine (NAG) or repeating units of NAG that are more accessible to beneficial gut bacteria. In some embodiment, a commensal organism containing the GH46 gene and expresses the enzyme such as P. claussenii is used to facilitate degradation of chitin or chitosan. Other major polysaccharides include components of plant cell walls, such as rhamnogalacturonan, xyloglucan, mannans, glucomannans, pectins, homogalacturonan, and arabinogalacturonans. Other useful polysaccharides include pectin, such as from applecake, cacao hulls, orange peel, sugar beet that have viable compositions and can result in more selectivity compared to other simpler repeating unit polymer compositions. Pectins may include rhamanose, arabinose, fucose, mannose, and xylose.

The above methods for formulating dietary fiber that feed certain populations of bacteria within the microbial food chain can be used with or without the corresponding bacteria to directionally shift the microbiome to establish and/or retain a gut microbiome highly enriched in certain bacterial species within the gut microbiome of a mammal.

### Commensal Bacteria

These oligosaccharide structures are used to promote growth of Bifidobacterium, and/or Lactobacilus and/or Pediococcus. The bacteria can be a single bacterial species of Bifidobacterium such as, but not limited to, B. adolescentis, B. animalis (e.g., B. animalis subsp. animalis or B. animalis subsp. lactis), B. bifidum, B. breve, B. catenulatum, B. longum (e.g., B. longum subsp. infantis or B. longum subsp. longum), B. pseudocatanulatum, B. pseudolongum, a single bacterial species of Lactobacillus, such as, but not limited to, L. acidophilus, L. antri, L. brevis, L. casei, L. coleohominis, L. crispatus, L. curvatus, L. equi, L. fermentum, L. gasseri, L. johnsonii, L. mucosae, L. pentosus, L. plantarum, L. reuteri, L. rhamnosus, L. sakei, L. salivarius, L. paracasei, L. kisonensis., L. paralimentarius, L. perolens, L. apis, L. ghanensis, L. dextrinicus, L. shenzenensis, L. harbinensis, or a single bacterial species of Pediococcus, such as, but not limited to P. parvulus, P. lolii, P. acidilactici, P. argentinicus, P. claussenii, P. pentosaceus, or P. stilesii, or it can include two or more of any of these species. In some of the embodiments which involve multiple species, at least one of the species will be capable of consuming MMO by the internalization of that intact MMO within the bacterial cell itself.

In some embodiments, the bacteria composition will include bacteria activated for colonization of the colon. The bacteria may be in an activated state as defined by the expression of genes coding for enzymes or proteins such as, but not limited to, fucosidases, sialidases, extracellular glycan binding proteins, and/or sugar permeases. Such an activated state is produced by the cultivation of the bacteria in a medium comprising a MMO prior to the harvest and preservation and drying of the bacteria. Activation of B. infantis is described, for example, in International Patent Application Publication No. PCT/US2015/057226, the disclosure of which is incorporated herein in its entirety.

In a preferred embodiment the bacterial compositions comprise bifidobacteria. In a more preferred embodiment the bifidobacteria is B. longum or B. breve. In a particularly preferred embodiment the B. longum is B. longum subsp. infantis. In other preferred embodiments, the bacterial compositions comprise Lactobacillus. In other particularly preferred embodiments, the bacterial composition the Lactobacillus is Lactobacillus reuteri. In another preferred embodiment, the lactobacillus is L. plantarum or L. equi. In other inventions, Pediococcus is selected for use in pigs. In particular Pediococcus acidilactici is selected. For use in this invention, the bacteria may be grown axenically in an anaerobic culture, harvested, and dried using, but not limited to, freeze drying, spray drying, or tunnel drying. In a preferred embodiment the bacteria is cultivated in the presence of MMO, whose presence activates the bacteria as described above.

### Use of Oligosaccharides

In some embodiments, oligosaccharides of chain length DP3-10 are administered to a mammal, in particular a mammalian infant, including a human infant. The oligosaccharides may be predigested polysaccharide product. In some embodiments, the resulting oligosaccharides act as a replacement for HMO in infants receiving infant formula. In some embodiments, the oligosaccharide composition is administered with organisms capable of fermenting the oligosaccharides in the predigested polysaccharide mixture, such as bifidobacteria, lactobacillus or pediococcus. The oligosaccharides can be administered in a food composition, such as mammalian milk, mammalian milk-derived product, mammalian donor milk, infant formula, a milk replacer, an enteral nutrition product, and/or a meal replacer. The oligosaccharides can be administered in a powder that may be in a sachet, stickpack, capsule, tablet, or it may be a liquid such as in a syrup form, or may be suspended in other liquids including non-aqueous solutions.

In any of the above embodiments, the oligosaccharides can include the carbohydrate polymers found in mammalian milk, which are not metabolized by any combination of digestive enzymes expressed by mammalian genes. The selective oligosaccharides composition can include one or more of lacto-N-biose (LNB), N-acetyl lactosamine, lacto-N-triose, lacto-N-tetraose (LNT), lacto-N-neotetraose (LNnT), fucosyllactose (FL), lacto-N-fucopentaose (LNFP), lactodifucotetraose, (LDFT) sialyllactose (SL), disialyllacto-N-tetraose (DSLNT), 2′-fucosyllactose (2FL), 3′-sialyllactosamine (3SLN), 3′-fucosyllactose (3FL), 3′-sialyl-3-fucosyllactose (3S3FL), 3′-sialyllactose (3 SL), 6′-sialyllactosamine (6SLN), 6′-sialyllactose (6SL), difucosyllactose (DFL), lacto-N-fucopentaose I (LNFPI), lacto-N-fucopentaose II (LNFPII), lacto-N-fucopentaose III (LNFPIII), lacto-N-fucopentaose V (LNFPV), sialyllacto-N-tetraose (SLNT), their derivatives, or combinations thereof. The OS can include: (a) a Type II oligosaccharide core where representative species include LnNT; (b) one or more oligosaccharides containing the Type II core and GOS in 1:5 to 5:1; (c) one or more oligosaccharides containing the Type II core and FL 1:5 to 5:1; or (d) one or more oligosaccharides containing the Type II core and SL 1:5 to 5:1; or (e) a combination of (a)-(d). The OS can include: (a) a Type I oligosaccharide core where representative species include LNT; (b) one or more oligosaccharides containing the Type I core and GOS in 1:5 to 5:1; (c) one or more oligosaccharides containing the Type I core and FL 1:5 to 5:1; (d) one or more oligosaccharides containing the Type I core and SL 1:5 to 5:1; or (e) a combination of (a)-(d). In some embodiments, Type I and Type II oligosaccharides in combination with any of GOS, FL, or SL. Type I or type II may be isomers of each other. Other type II cores include but are not limited to trifucosyllacto-N-hexaose (TFLNH), LnNH, lacto-N-hexaose (LNH), lacto-N-fucopentaose III (LNFPIII), monofucosylated lacto-N-Hexose III (MFLNHIII), Monofucosylmonosialyllacto-N-hexose (MFMSLNH).

### Weaning

Certain embodiments of the instant invention pertain to food and probiotic compositions, formulated and used for the express purpose of increasing the diversity of the microbiota in the colon, where such uses include, but are not limited to, the weaning of an infant mammal from its mother's milk, the weaning of any mammal from a course of antibiotics, the weaning of any mammal from a medical procedure that reduces microbiome complexity (e.g., a course of chemotherapy, or use of total enteral nutrition), or the preparation for and application of a FMT procedure to increase microbiome complexity. In a preferred embodiment, the mammal includes, but is not limited to, a human, pig, cow, goat, sheep, horse, dog, or cat. In a particularly preferred embodiment, the mammal is a human. In some embodiments of the invention, the probiotic bacteria include, but are not limited to, commensal bacteria that typically reside in the lower intestine, or colon. In a preferred embodiment, the bacteria include, but not limited to, those of the genus Lactobacillus, Pediococcus and Bifidobacterium. In certain embodiments of the instant invention, the foods include, but are not limited to, complex oligosaccharides and glycans from meat, fish, milk, eggs, shellfish, fruits, vegetables, grains, nuts, and seeds in whole or a processed form. In some embodiments of the instant invention, certain bacterial species including, but not limited to, those from the genus Lactobacillus, Pedicococcus or Bifidobacterium, are combined and delivered with the food in a way that facilitates consumption of FSMs in the GI tract by commensal bacteria, which mitigates the possibility of pathogenic blooms of unwanted or unhealthy bacteria. See, e.g., International Patent Application Publication No. WO 2016/149149, the disclosure of which is incorporated herein by reference in its entirety.

A mammal that is receiving a sole source of nutrition (e.g., oligosaccharides of the sort found in mammalian milk (MMO)), such as, but not limited to a breast fed human infant, and where the microbiome of this mammal is dominated by one or a few species of microbe that are particularly adapted to grow on those oligosaccharides as a carbon source, can be weaned to a more complex and varied diet by administering a diet comprising the following: a bifidobacteria (e.g., B. infantis), MMO in a reduced amount, non-milk oligosaccharide compound(s) of the new dietary component(s) in an amount less than that of the MMO, and a probiotic composition competent to metabolize the sugar components of the non-milk oligosaccharides. After a period on this diet, the diet administered to this mammal is adjusted by reducing the amount of the bifidobacteria (e.g., B. infantis) while MMO and the amount of non-milk oligosaccharide compound(s) is increased along with additional probiotic cells. Successive stages of continued decreasing and/or increasing, respectively, of the components can follow. In any of the above embodiments, the probiotic composition should be selected based on the non-milk oligosaccharide compound. For example, the probiotic composition can be selected based on the carbohydrate residues present in the non-milk oligosaccharide compound(s), and the bacteria's preference for the carbon compound(s).

Typically, feeding the controlled diet to the mammal is continued for a period of days to weeks, for example, following the reduction in breastmilk, an increase in formula feeding, an increase in complementary foods, administration (and/or cessation) of antibiotics, administration (and/or cessation) of chemotherapy, and infusion of the fecal microbial transplant composition. Any of the embodiments described herein may include the administration of compositions of varying MMO and non-milk food dietary fibers. For example, the initial stage of administration may include a composition where the MMO provides more than 50% of the dietary fiber of the composition, and where the non-milk food provides less than 50% of the dietary fiber of the composition. A later stage of administration may include a composition where the MMO provides less than 50% of the dietary fiber of the composition, and where the non-milk food provides more than 50% of the dietary fiber of the composition.

The MMO used for this invention can include fucosyllactose (FL) or derivatives of FL including but not limited to, lacto-N-fucopentose (LNFP) and lactodifucotetrose (LDFT), N-acetlylactosamine, Lacto-N-Biose (LNB), lacto-N-tetraose (LNT) and lacto-N-neotetraose (LNnT), which can be purified from mammalian milk such as, but not limited to, human milk, bovine milk, goat milk, or horse milk, sheep milk or camel milk, or produced directly by chemical synthesis. The composition can further comprise one or more bacterial strains with the ability to grow and divide using fucosyllactose or its derivatives thereof as the sole carbon source. Such bacterial strains may be naturally occurring or genetically modified and selected to grow on the fucosyllactose or its derivatives if they did not naturally grow on those oligosaccharides.

The MMO can also be sialyllactose (SL) or derivatives of SL such as, but not limited to, 3′ sialyllactose (3SL), 6′ sialyllactose (6SL), and disialyllacto-N-tetrose (DSLNT), which can be purified from mammalian milk such as, but not limited to, human milk, bovine milk, goat milk, or mare's milk, sheep milk or camel milk, or produced directly by chemical synthesis. The composition further comprises one or more bacterial strains with the ability to grow and divide using sialyllactose or derivatives thereof as the sole carbon source. Such bacterial strains may be naturally occurring or genetically modified and selected to grow on the sialyllactose or its derivatives, if they did not naturally grow on those oligosaccharides.

In other embodiments, the polysaccharide digesting organism is freeze-dried and added to the composition. In further embodiments, these compositions are used as a component of a weaning food. In other embodiments, the digested polysaccharide is further modified.

In some embodiments, the ratio of the predigested polysaccharide to whole polysaccharide is changed as the infant progresses in the weaning process.

In some embodiments, a fermentate that has the organism plus the partially or wholly digested polysaccharide can be administered. The fermentate may be a powder or a liquid concentrate. In other embodiments, the fermentate or supernatant (dried or liquid) is added to a food composition, including a weaning food.

In some embodiments, the pre-digested polysaccharide is used to stimulate an endogenous Lactobacillus population. In other embodiments, freeze-dried Lactobacillus product is added to the food containing the pre-digested polysaccharide. In further embodiments, the predigested polysaccharides are added to intact polysaccharide in specified ratios in the weaning food. In further embodiments, freeze-dried Bacteroides species (i.e., B. diastonis, B. fragilis, B. thetaiotaomicron) is added to the food. It may be mixed with the weaning food during production or added from a sachet at time of consumption.

Some embodiments of the invention relate to a method to maintain or provide at least about 10%, at least about 20%, at least about 30%, at least about 40%, or at least about 50% of an infant mammal's microbiome as Bifidobacterium (e.g., B. infantis) during at least a portion of the weaning process by providing a weaning food comprising a food source appropriate for an infant mammal, MMO, and bifidobacteria (e.g., B. infantis).

In yet another mode, this invention provides a method of increasing the gut microbiome complexity in a human in need thereof consisting of (a) preparing a dry composition of a weaning food by cooking the food, drying the cooked food and milling the dried food to a powder usable as a weaning food; (b) growing a culture of Bifidobacterium and/or Lactobacillus which is selected from a group that consumes FSMs found in the feces of an infant fed a similar weaning food, harvesting the culture and drying the cell mass in the presence of a preservative; and (c) combining the dry composition of weaning food with the dry composition of bacterial culture in a ratio of from 10⁸-10¹² CFU of bacterial culture to 100 g of weaning food.

In some embodiments, the presence of at least one glycoside hydrolase, such as but not limited to GH5, GH43, GH13, or GH92 is monitored as a marker of weaning. In other embodiments, the level of one or more of these glycoside hydrolases are increased by adding bacteroides species, such as but not limited to B. diastonis, B. fragilis, B. thetaiotaomicron. (In alternative embodiments, a preparation of glycoside hydrolases is added as digestive aide to reach the large intestine of a mammal in need of increasing dietary fiber, in place of or in addition to the microbial component.) In further embodiments, the bacteroides and/or the enzyme preparation is given in conjunction with polysaccharides.

In another embodiment, pectin from vegetables (e.g. tomato, capsicum) is treated with a GH28 family enzyme to reduce the chain length. Reduced chain length of the pectin has been shown to improve growth of B. infantis or B. adolescentis on the substrate (Gibson et al. 2004. Nutrition Research Review Volume 17, Issue 2 Dec. 2004, pp. 259-275), and because these Bifidobacterium lack this enzyme, its addition as a pretreatment can enable their growth in vivo. This can improve the growth of these Bifidobacterium in vivo and/or improve the sensory or functional characteristics of the food/ingredient. In other embodiments, algae and/or yeast extracts are used as a source of complex polysaccharides.

In another embodiment, a GH5 endoglucanase can be added to reduce chain length of cellulose or a GH13 can be used to reduce chain length of starches (amylopectin) down to DP3-10 to improve the growth of this specific organism and/or sensory or functional characteristics of the food/ingredient. In some embodiments, GH5 and GH43 are used in combination.

In another embodiment, EndoBI-1, a GH18 enzyme found in B. infantis, which has been shown to have activity on N-linked glycoproteins found in milk, could be utilized to release N-linked glycans associated with plant glycoproteins to release high-mannose or hybrid glycans from the protein structure as described in Kavav, Sercan et al. “Kinetic Characterization of a Novel Endo-β-N-Acetylglucosaminidase on Concentrated Bovine Colostrum Whey to Release Bioactive Glycans.” Enzyme and Microbial Technology 77 (2015): 46-53. PMC. Web. 8 Sep. 2017. Once released, these structures can have prebiotic activity, stimulating the growth of B. infantis in vivo.

In other embodiments, a combination of enzymes is used to make mammalian milk oligosaccharides or released glycans less selective for B. infantis to allow for the expansion of Lactobacillus during the transition from a B. infantis-dominated to a more diverse microbiome during the weaning process. Further embodiments could include the use of a GH29 or GH95 fucosidase to remove fucose moieties from the structure to increase its utilization among bacteria where these structures are absent, but mannosidases (GH92) are more abundant (e.g. Bifidobacterium adolescentis). In other embodiments the abundance of infant-associated Bifidobacterium is shifted to adult-associated Bifidobacterium using structures preferred by GH92 containing organisms. Any or all of these treatments can be done in conjunction with acid hydrolysis or other methods of physical or chemical disruption of the bonds.

TABLE 1
Listing of common weaning foods and expected Free Sugar
Monomers to be released under normal digestive processes.

| | Monosaccharides | | | | | | | | | | | | |
|---|---|---|---|---|---|---|---|---|---|---|---|---|---|
| Weaning Foods | Glc | Gal | Man | Xyl | Fru | Rha | Neu5Ac | Neu5Gc | GlcNAc | GalNAc | Arb | GlcA | GalA |
| Grains/Cereals | | | | | | | | | | | | | |
| Barley | x | | x | x | | | | | | | x | | |
| Corn | | | | | | | | | | | | | |
| hummus | | | | | | | | | | | | | |
| Lentils | x | x | | | x | | | | | | | | |
| Oats | | | | | | | | | | | | | |
| Rice | x | | | | | | | | | | | | |
| Wheat | X | | | x | X | | | | | | x | | |
| Vegetables | | | | | | | | | | | | | |
| Avocado | X | | | | X | | | | | | | | |
| Beetroot | X | | | | X | | | | | | | | |
| Broccoli | X | | | | X | | | | | | | | |
| Squash | X | | | X | | | | | | | X | X | X |
| Carrots | X | X | | X | X | | | | | | | X | X |
| Green Beans | | X | | | | X | | | | | X | | X |
| Peas | X | | | | X | | | | | | | | |
| Potato | X | X | | X | X | X | | | | | | | X |
| Casava | X | X | | X | X | X | | | | | | | X |
| Sweet potato | X | X | | X | X | | | | | | | | X |
| Pumpkin | X | X | | | | | | | | | | | |
| Fruits | | | | | | | | | | | | | |
| Apple | X | X | | X | | | X | | | | X | | X |
| banana/plantain | X | X | | X | | | X | | | | X | | X |
| Blueberry | X | X | | X | | | X | | | | X | | X |
| Mango | X | X | | X | | | X | | | | X | | X |
| Peach | X | X | | X | | | X | | | | X | | X |
| Pear | X | X | | X | | | X | | | | X | | X |
| Papaya | X | X | | X | | | X | | | | X | | X |
| Watermelon | X | X | | X | | | X | | | | X | | X |
| Meats | X | X | X | | | | X | | X | X | | | |
| Fish | X | X | X | | | | X | | X | X | | | |
| Cheese/Dairy | X | X | X | | | | X | X | X | X | | | |

TABLE 2
Listing of common intestinal microbiota and preferences for free sugar consumption.

| | | | | | | | | |
|---|---|---|---|---|---|---|---|---|
| | Sialic | N-Acetyl- | | | | Sialyl- | Fucosyl- | Lacto-N- |
| Fucose | Acid | glucosamine | Glucose | Galactose | Lactose | lactose | lactose | Biose |

Bifidobacterium

| | | | | | | | | | |
|---|---|---|---|---|---|---|---|---|---|
| B. infantis | * | + | + | + | + | + | + | + | + |
| B. breve | * | + | + | + | + | + | + | + | + |
| B. bifidum | * | − | + | + | + | + | + | + | + |
| B. longum | * | − | + | + | + | + | − | − | + |
| B. adolescentis | − | − | + | + | + | + | − | − | − |
| B. animalis | − | − | − | + | + | + | − | − | − |

Lactobacillus

| | | | | | | | | | |
|---|---|---|---|---|---|---|---|---|---|
| L. reuteri | − | − | + | + | + | + | − | − | − |
| L. acidophilus | − | − | + | + | + | + | − | − | − |
| L. plantarum | − | + | + | + | + | + | − | − | − |
| L. casei | − | − | + | + | + | + | − | + | + |
| L. rhamnosus | − | − | + | + | + | + | − | + | − |
| L. brevis | − | − | + | + | + | + | + | − | − |
| L. fermentum | − | − | − | + | + | + | − | − | − |
| L. crispatus | − | + | + | + | + | + | − | − | − |
| L. johnsonii | − | − | + | + | + | + | − | − | − |
| L. gasseri | − | + | + | + | + | + | − | − | − |
| L. mucosae | − | − | − | + | + | + | − | − | − |
| L. salivarius | − | + | + | + | + | + | + | − | − |

Pediococcus

| | | | | | | | | | |
|---|---|---|---|---|---|---|---|---|---|
| P. stilesii | + | ND | + | + | + | + | ND | ND | ND |
| P. pentosaceus | + | ND | + | + | + | + | ND | ND | ND |
| P. acidilacti | − | ND | + | + | + | − | ND | ND | ND |
| P. argentinicus | − | ND | + | + | + | − | ND | ND | ND |

| | | | | | | |
|---|---|---|---|---|---|---|
| Mannose | Xylose | Fructose | Rhamnose | Arabinose | Glucuronate | Galacturonate |

Bifidobacterium

| | | | | | | | |
|---|---|---|---|---|---|---|---|
| B. infantis | −/v | − | + | − | − | + | − |
| B. breve | + | − | + | − | − | − | − |
| B. bifidum | − | − | + | − | − | − | − |
| B. longum | − | + | + | − | + | − | − |
| B. adolescentis | − | − | + | − | − | − | − |
| B. animalis | − | + | − | − | + | − | − |

Lactobacillus

| | | | | | | | |
|---|---|---|---|---|---|---|---|
| L. reuteri | + | − | + | + | + | ND | ND |
| L. acidophilus | + | − | + | − | − | ND | ND |
| L. plantarum | + | − | + | − | + | ND | ND |
| L. casei | + | − | + | − | − | ND | ND |
| L. rhamnosus | + | − | + | + | − | ND | ND |
| L. brevis | − | v | + | − | + | ND | ND |
| L. fermentum | + | − | + | − | v | ND | ND |
| L. crispatus | + | − | + | − | − | ND | ND |
| L. johnsonii | + | − | + | − | − | ND | ND |
| L. gasseri | + | − | + | − | − | ND | ND |
| L. mucosae | − | + | + | − | + | ND | ND |
| L. salivarius | + | − | + | + | − | ND | ND |

Pediococcus

| | | | | | | | |
|---|---|---|---|---|---|---|---|
| P. stilesii | + | − | + | + | − | ND | ND |
| P. pentosaceus | + | − | + | − | + | ND | ND |
| P. acidilacti | + | + | + | − | + | ND | ND |
| P. argentinicus | + | − | + | − | − | ND | ND |

* = predicted, but not observed;
ND = Not Determined

### EXAMPLES

### Example 1. Method of Selecting Oligosaccharides for Targeted Enrichment of Lactobacillus In Vivo

Lactobacillus reuteri is a native human gut symbiont historically present in the gut microbiome of adults and is known to grow on arabinose and utilize rhamnose as a terminal electron acceptor to improve its growth (Rattanaprasert et al. 2014 Journal of Functional Food: 85-94), but it is unable to consume complex starches (Fooks and Gibson et al 2002 EMS Microbiol Ecol: 39(1):67-75). The inventors first analyzed 300 infants' metagenomic data generated from stool samples that were collected from the first year of life though weaning to determine if there was a characteristic pattern for carbohydrate utilization genes in the microbiome.

Newborn infant diets are devoid of plant-derived polysaccharides. The act of adding plant-derived polysaccharides to an infant diet initiates a process of weaning. The steps required to produce a productive and healthy microbiome involve three dependent features to effectively adapt and use new dietary fiber in the diet: 1) sufficient glycosyl hydrolases to make the polysaccharide accessible; 2) a microbial species which consume the smaller oligosaccharides making these microbes beneficial to the host; and 3) the beneficial bacteria should be present and competitive in the intestinal microbiome. Analysis of the 300 weaning samples determined that Lactobacillus increases during weaning (Cell Host Microbe, Dynamics and Stabilization of the Human Gut Microbiome during the First Year of LifeBackhed et al 2015. Lactobacillus reuteri is an example of one such Lactobacillus species that is classified as a beneficial, commensal organism. Further metagenomics analysis determined the contribution of different organisms to the GH content of the weaning infant gut.

However, Lactobacillus species do not contribute to the genetic potential for glycosyl hydrolases required to adapt and use new dietary fiber, such as rice or wheat. introduced during weaning.

TABLE 3
The total bacterial contribution to annotation of metagenome. The
metagenome sequences were annotated, and the contribution of
Bacteroides and Lactobacillus were compared.

| Type of Glycosyl | Bacteroides | Lactobacillus |
|---|---|---|
| hydrolase | (% contribution) | (% contribution) |
| GH5 | 77.8 | 0 |
| GH28 | 74.9 | 0 |
| GH29 | 81.5 | 0 |
| GH92 | 81.6 | 0 |
| GH95 | 86.41 | 0 |

The process of generating the oligosaccharide can be achieved by any combination of methods that include acid hydrolysis, ionic fluids, sonication, pressure or enzymatic digestion. The subsequent fractions are separated first by size to achieve a composition enriched for DP3-10 or based on their chemical properties. DP3-10 is a desirable chain length size for Lactobacillus and Bifidobacterium.

The DP3-10 fraction is then tested for its ability to selectively enrich for the growth of a target species of bacteria, such as a Lactobacillus, Akkermansia, Roseburia, or Bifidobacterium. Selectivity is confirmed by growing the bacteria on this fraction as a sole carbon source under appropriate conditions, and comparing that growth to the growth of a non-desirable bacterium, such as Staphylococcus, E. coli or Klebsiella. A highly selective oligosaccharide fraction will support the growth of the desirable bacteria and not support, or only weakly support, the growth of the non-desirable organism.

The composition of the oligosaccharide fraction is determined by a combination of LC/MS and enzymatic hydrolysis to determine degree of polymerization, and/or composition and/or specific types of linkages. Briefly, a liquid-liquid extraction such as the Folch extraction (Aldredge et al. (2013) Glycobiology 23(6): 664-676) is used to separate the carbohydrates from other components based on polarity. Carbohydrates are retained in the methanol/water fractions. The organic solvent is then evaporated and the carbohydrates are re-dissolved in a low conductivity water. A 0.2 μm filtration step is used to remove precipitate from the solution prior to analysis. Purity of the extraction is confirmed, as necessary using nLC-MS. Depending on the complexity of the carbohydrate source, an additional purification step can be used such as solidphase extraction with a nonporous graphitized carbon (GCC-SPE) cartridge and a series of acetonitrile/water washes (Ninoneuvo et al. (2006) J. Agric. Food Chem. 54(20): 7471-7480). Further fractionation with higher concentrations of acetonitrile in trifluoroacetic acid allow less complex carbohydrate mixtures to be analyzed via mass spectrometry. These extractions result in a number of GCC-SPE fractions, if each fraction contains 10 or less oligosaccharides then these fractions are analyzed using a Matrix Assisted Laser Desorption Ionization-Time Of Flight (MALDI-TOF) mass spectrometer for high accuracy mass resolution (e.g., 50 ppm or less mass error) and robustness. Samples are ionized with the aid of a laser energy absorbing molecule (matrix) in positive mode. Ions then fly in an electromagnetic field under vacuum and are separated based on its mass to charge (m/z) ratio. For carbohydrate applications, a 1 μL of 2,5-dihydroxybenzoic acid (2,5-DHB) matrix and sample mixture resuspended in water/acetonitrile is placed on a target plate and left to air dry for 5 minutes. The same procedure is applied for external calibration standards (e.g., DP3 to DP10 malto-oligosaccharides).

A suitable range for initial identification of ionized oligosaccharides is 300 to 1500 m/z. Further fragmentation of the ions via tandem mass spectrometry is required for full characterization; however, this technique will not resolve isomers. In cases where 10 or more oligosaccharides are found in each fraction, nano Liquid Cromatography-Mass Spectrometer (nLC-MS) is used to characterize the fraction. The LC component will further separate complex mixtures of analytes which are then selected for fragmentation with the aid of the ion chromatogram. For the MS component high mass accuracy MS such as a qTOF, triple-quad or orbitrap is appropriate to resolve the structures. The Q Exactive MS from Thermo Scientific can be added as an additional detector for the IC-5000 (Dionex) to determine abundance of unknown oligosaccharide structures. This is an Orbitrap-type of mass spectrometer with high resolution because of the TOF feature of the ion trap. If so, a trap-column is placed in between the LC and MS modules for sample desalting prior to identification/characterization. The carbohydrates are separated with a CarboPac PA200 or PA1 guard and analytical column and eluted in a gradient of high concentration sodium acetate (e.g., 0.5-1 M)/sodium hydroxide mixture. Initial identification will then occur at a 300 to 1500 m/z range. To resolve sugar linkages for proper isomer characterization, enzymatic hydrolysis is required.

Overall, the process provides a specific composition which facilitates Lactobacillus reuteri enrichment in the infant when polysaccharide-containing food is added to the infant diet.

### Example 2. The Predigestion of Wheat Bran Polysaccharide Using Enzymatic Methods

The GH-5 enzyme is cloned from Bacteroidetes and expressed in E. coli. The recombinant E. coli is grown in production fermentation tanks and the GH-5 enzyme is harvested, purified, and immobilized on a bead. An arabinoxylan-enriched food (e.g. rice or wheat, their bran, or a combination thereof) is mixed with the immobilized GH5-family enzyme during processing to reduce complex arabinoglycan size and improve functional properties of the food, including the stimulation of Lactobacillus in vivo.

The food containing DP3-10 sized arabinoxylan in the process outlined here may be fed to a weaning infant to stimulate the endogenous lactobacillus population in the infant gut.

The powdered arabinoxylans of DP3-10 may also be combined with the powdered freeze-dried preparation of lactobacillus in a dried weaning cereal. In this embodiment, the weaning food is mixed with breast milk, infant formula or water to make a paste that is fed to the infant.

### Example 3a: Production of an Oligosaccharide Composition by Acid Hydrolysis of a Plant Polysaccharide

Steamed vegetables are pureed and contacted with hydrochloric acid (safe for food processing) for 2 minutes or until the mixture contains predominantly DP3-10 chain length. The reaction is quenched using NaOH and the salt content is adjusted to below acceptable levels for an infant food using non-hydrolyzed mixed vegetable puree. The resulting oligosaccharide-enriched vegetable product may be packaged in pouches as first foods for weaning infants or the oligosaccharide may be further purified to remove the other hydrolyzed products from the vegetables.

### Example 3b: Production of a Purified Oligosaccharide Composition by Acid Hydrolysis of a Plant Polysaccharide

Insoluble fiber of the broccoli, spinach, and carrot is collected after a process of juicing the vegetables, and thoroughly rinsed with water. The purified fiber is contacted with with hydrochloric acid. The reaction is left for 10 minutes or until the mixture contains predominantly DP3-10 chain length. Hydrochloric acid is safe for use in food processing. The soluble portion of the material is collected by evaporating the water using a speedvac, washed by resuspending in water, and the water evaporated again using the speedvac. The concentrate is collected and dried by freeze drying or spray drying to produce an oligosaccharide powder. The oligosaccharides can also be extracted using liquid:liquid extractions or solidphase extractions.

### Example 4: Production of an Oligosaccharide Composition by Acid Hydrolysis in an Ionic Liquid

The fiber material from juicing as in example 3b is hydrolyzed by exposing the polysaccharides to a catalyst (ionic solvent tolerant enzyme) that selectively cuts glycosidic bonds using ionic liquid solvents with high thermal stability, low flammability and very low volatility such as, but not limited to 1-ethyl-3-methylimidazolium acetate ([EMIM]AcO), 1-allyl-3-methylimidazolium chloride ([AMIM]Cl), 1-butyl-3-methylimidazolium chloride ([BMIM]Cl) and dialkylimidazolium dialkylphosphates (Wahlstrum and Suurankki (2015) Green Chem 17:694).

### Example 5. Production of an Oligosaccharide Composition by an Acid Ionic Liquid Containing Sulfuric Acid and 1-(1-Butylsulfonic)-3-Methylimidazolium Hydrosulfate

The polysaccharide is mixed with sulfuric acid and 1-(1-butylsulfonic)-3-methylimidazolium hydrosulfate at 100° C. (Satrai et al Sustainable Chem. Eng., 2017, 5 (1), pp 708-713). The aqueous phase is collected, centrifuged, resuspended in water to remove any potential processing chemicals before fractionating into a DP3-10 enriched fraction that is dried and used in weaning food applications.

### Example 6. Preparation of a Weaning Baby Food Containing Plant Oligosaccharides

Oligosaccharides fractions produced as a result of any of the processes described in 1-5 are screened for their ability to promote the growth of Lactobacillus reuteri over B. infantis and/or B. breve. The oligosaccharide fraction is incorporated into a dry first weaning food. The preparation may include Lactobacillus reuteri.

### Example 7. Preparation of an Infant Formula Containing Plant Oligosaccharides

Oligosaccharides fractions produced as a result of any of the processes described in 1-5 are screened for their ability to promote the selective growth of B. infantis and/or B. breve. The fraction of dried plant-based oligosaccharides is selected for its preference for infant-adapted organisms such as B. infantis or B. breve, as well as its flowability and/or its water activity, dried and prepared for addition to an infant formula formulation, where it may be all or part of the total oligosaccharide fraction. The plant-based oligosaccharides are added to a dried infant formula, such that the total formula represents a complete nutrient source for that infant.

### Example 8. Preparation of a Sachet Containing Plant Oligosaccharides

Oligosaccharides fractions produced as a result of any of the processes described in 1-5 are screened for their ability to promote the selective growth of B. infantis and/or B. breve and/or Lactobacillus reuteri in a powder or liquid form. A sterile liquid oligosaccharide fraction can be packaged into a sachet. The liquid oligosaccharide product can be added to a cereal. The resulting mixture is a paste of suitable consistency for feeding to an infant learning to swallow solids. The liquid oligosaccharide sachet can also be used to thin out a food that is delivered as a thick paste or be added directly to a liquid food. This composition is designed to assist in preparing the infant gut for the concomitant or subsequent addition of a food to the infant diet.

### Example 9. Preparation of a Sachet Containing Plant Oligosaccharides and Bifidobacteria (for Addition to a Baby Food or Formula)

Oligosaccharides from any process that reduces the DP to 3-10 and that are food sources for Bifidoabacteria are dried and added to a sachet with B. infantis at a final concentration of 8 billion Colony Forming Units (CFU) per sachet. The oligosaccharides are used as an excipient to get to the desired CFU count/gram of material.

### Example 10. Preparation of Weaning Food for a Pig

Viscous Oat B-glucan polysaccharide is hydrolyzed to DP3-10 according to the process of any of Examples 1-5. The oligosaccharide fraction is dried. The β-glucan is added to a freeze-dried preparation containing Pediococcus and Bifidobacterium so that the final bacteria concentrations are about 8 Billion per gram. The resulting mixture is then packaged in sachets at 8 gram/sachet. The sachet containing the combination of the β-glucan oligosaccharide mixture, Bifidobacterium and Pediococcus is sprinkled on top of a creep feed given to to a nursing litter or added to the feed of a weaning piglet.

### Example 11. Preparation of a Transition Food for a Horse

A transition feed for a nursing foal is prepared by 1) preparing a mixture of Kentucky blue grass, alfalfa and corn silage that contains cellulose and hemi-cellulose where the sugars comprise glucose, galactose, arabinose, xylose, and mannose; 2) hydrolyzing the mixture using examples 1-5 to produce oligosaccharides of DP3-10; and 3) drying the mixture. The transition feed is combined with L. equi, L. plantarum, B. longum and B. infantis and packaged into a sachet to keep water activity and oxygen low. One sachet of the complete mixture is added to water or mare's milk and given to the foal each day during weaning.

1. An oligosaccharide composition, wherein the composition comprises oligosaccharides having over 50%, over 60%, over 70%, over 80%, or over 90% degree of polymerization from DP3-DP10, and wherein preparation of the composition comprises the steps of incubating one or more plant polysaccharides with one or more endoglucanases.

2. The composition of claim 1, wherein the endoglucanases are chosen from families GH5, GH13, GH18, GH28, GH 29, GH43, GH92, and GH95.

3. The composition of any one of claims 1-2, wherein a chitin or chitosan polymer is substituted for the plant polysaccharides.

4. An oligosaccharide composition, wherein the composition comprises oligosaccharides having over 50%, over 60%, over 70%, over 80%, or over 90% degree of polymerization from DP3-DP10, and wherein preparation of the composition comprises the steps of:
(a) incubating one or more plant polysaccharides with a thermostable ionic liquid with or without a catalyst; and
(b) stopping the reaction by the addition of an equal volume of water into which the monomers, dimers, and oligosaccharides will dissolve.

5. The composition of claim 4, wherein the ionic liquid is selected from the group consisting of 1-ethyl-3-methylimidazolium acetate ([EMIM]AcO), 1-allyl-3-methylimidazolium chloride ([AMIM]Cl), 1-butyl-3-methylimidazolium chloride ([BMIM]Cl) and dialkylimidazolium dialkylphosphates and the catalyst comprises ionic liquid solvent tolerant glycoside hydrolase.

6. An oligosaccharide composition, wherein the composition comprises oligosaccharides having over 50%, over 60%, over 70%, over 80%, or over 90% degree of polymerization from DP3-DP10, and wherein preparation of the composition comprises the steps of:
(a) incubating one or more plant polysaccharides with a concentrated acid; and
(b) stopping the reaction by neutralizing the acid with a strong base.

7. The composition of claim 6, wherein the strong acid is sulfuric, hydrochloric, uric, or, triflouroacetic.

8. The composition of claim 6 or 7, wherein the strong base is sodium or potassium hydroxide.

9. The composition of any one of claims 6-8, wherein a chitin or chitosan polymer is substituted for the plant polysaccharides.

10. The composition of any one of claims 1-8, wherein the plant polysaccharides are from carrots, peas, broccoli, onions, tomato, pepper, rice, wheat, oats, bran, orange peel, cocao hulls, olive pomace, applecake, cabbage or tomato skins, grape pomace, sugar beet, corn silage.

11. An oligosaccharide composition, wherein the composition comprises oligosaccharides having over 50%, over 60%, over 70%, over 80%, or over 90% degree of polymerization from DP3-DP10, and wherein preparation of the composition comprises the steps of:
(a) incubating one or more glycosylated protein with an N-linked and/or O-linked glycosyl hydrolase;
(b) separating the deglycosylated protein from the glycans; and
(c) incubating the glycans with one or more endoglucanases.

12. The composition of claim 11, wherein the N-linked glycosyl hydrolase is EndoB1 from Bifodobacterium subsp. infantis.

13. The composition of any one of claim 11 or 12, wherein the glycosylated protein comes from a plant, algal, fungal or bacterial source.

14. The composition of any one of claim 11 or 12, wherein the glycosylated protein come from an animal source.

15. An oligosaccharide composition comprising over 50%, over 60%, over 70%, over 80%, or over 90% of the oligosaccharides from DP3-DP10 prepared by subjecting one or more plant polysaccharides to a combination of physical stress including one or more of heat, sonication and pressure.

16. The composition of any one of claims 1-15, further comprising a step of removing the monomers, dimers and/or oligomers with DP>10 from the oligosaccharides.

17. The composition of any one of claims 1-15, wherein the monomers, dimers, and polymers >DP10 are removed from other oligosaccharides by filtration and/or through incubation with live yeast.

18. The composition of any one of claims 1-17, further comprising a step of drying the final oligosaccharide product.

19. A composition comprising:
(a) non-milk oligosaccharides produced according to any one of claims 1-16, wherein over 50% 60%, 70%, 80% or over 90% of the oligosaccharides have degree of polymerization from DP3-DP10; and
(b) one or more commensal bacteria capable of consuming the oligosaccharide fragments of said polysaccharide.

20. The composition of claim 19, wherein the commensal bacteria is one or more species of Bifidobacterium, Lactobacillus, and Pediococcus

21. The composition of claim 20, where in the Bifidobacterium is one or more of B. breve, B. longum subsp. infantis, B. longum subsp. longum and B. adolescentis.

22. The composition of claim 20, where in the Lactobacillus is one or more of L. plantarum, L. reuteri, and L. casei.

23. The composition of claim 20, where in the Pediococcus is one or both of P. clausseni, and P. acidilactici.

24. The composition of claim 19 or 20, wherein the oligosaccharide comprises arabinose and rhamnose residues, and the bacteria comprises Lactobacillis reuteri and/or Bacteriodetes sp.

25. The composition of any one of claims 1-24, further comprising a mammalian milk oligosaccharide (MMO).

26. The composition of claim 25, wherein the mammalian milk oligosaccharide (MMO) comprises oligosaccharide molecules found in human milk oligosaccharides (HMO), bovine milk oligosaccharides (BMO), bovine colostrum oligosaccharides (BCO), goat milk oligosaccharides (GMO), or a combination thereof.

27. The composition of any one of claims 25-26, wherein the mammalian milk oligosaccharide (MMO) comprises lacto-N-biose, lacto-N-triose, N-acetyllactosamine, lacto-N-neotriose, lacto-N-tetrose, lacto-N-neotetrose, fucosyllactose, lacto-N-fucopentose, lactodifucotetrose, sialyllactose, di sialyllactone-N-tetrose, 2′-fucosyllactose, 3′-sialyllactoseamin, 3′-fucosyllactose, 3′-sialyl-3-fucosyllactose, 3′-sialyllactose, 6′-sialyllactosamine, 6′-sialyllactose, difucosyllactose, lacto-N-fucosylpentose I, lacto-N-fucosylpentose II, lacto-N-fucosylpentose III, lacto-N-fucosylpentose V, sialyllacto-N-tetraose, their derivatives, or combinations thereof.

28. The composition of any one of claims 25-26, wherein the mammalian milk oligosaccharide (MMO) comprises lacto-N-biose or N-acetyllactosamine.

29. The composition of any one of claims 25-26, wherein the mammalian milk oligosaccharide (MMO) comprises lacto-N-triose (LNT) or lacto-N-neotetrose (LNnT).

30. The composition of any one of claims 1-29, wherein at least one of the oligosaccharides has a Type I or a II core, or at least one of each.

31. A baby food wherein at least 20%, at least 40%, at least 60%, at least 80%, or at least 95% of the total fiber is from plant-derived oligosaccharides.

32. The baby food of claim 31, wherein the plant-based oligosaccharides are predominantly between 1 and 10 sugar residues (DP1-DP10), between 3 and 10 sugar residues (DP3-DP10), or between 5 and 10 sugar residues (DP5-DP10).

33. The baby food of claim 31 or 32, wherein the composition further comprises polysaccharides greater than DP30.

34. A food composition for a geriatric individual wherein at least 20%, at least 40%, at least 60%, at least 80%, or at least 95% of the fiber is in the form of plant-based oligosaccharides with between 1 and 10 sugar residues, between 3 and 10 sugar residues, or between 5 and 10 residues.

35. A method to promote microbiome stability comprising administering a composition according to any one of claims 1-34.

36. A method for treating or preventing dysbiosis in a mammal comprising administering a composition according to any one of claims 1-34.

37. A method to promote gut health by including the composition any one of claims 1-34 in a human diet consumed contemporaneously with probiotic Bifidobacterium.

38. The method of claim 37, wherein the Bifidobacterium is one or more of B. longum subsp longum, B. longum subsp infantis or B. breve.

39. A method for improving a polysaccharide-containing food, said method comprising predigesting the food with a digestive agent comprising (a) one or more glycosyl hydrolases selected from GH5, GH13, GH43, or GH92; and/or (b) one or more microbes expressing the glycosyl hydrolase(s) of (a).

40. A method for facilitating microbiome development during weaning comprising administering a diet which includes arabinose-containing polysaccharide, wherein GH43-containing Bacteriodetes sp. are administered contemporaneously.

41. The method of claim 40, wherein Lactobacillus is added contemporaneously.

42. The method of claim 41, where the Lactobacillus is one or more of Lactobacillus reuteri L. plantarum and/or L. casei.

43. A method for facilitating microbiome development during weaning comprising administering a diet which includes pectin-containing vegetables, wherein GH28-containing bacteria are administered contemporaneously.

44. An infant formula comprising the composition of any one of claims 1-34, wherein the composition is provided in a ready-to-feed formulation at a level of from 0.2-20 g/L.

45. A method of treating or preventing intestinal distress during weaning comprising administering the composition of any one of claims 1-34, wherein the composition comprises weaning food and a bacterial culture.

46. The method of claim 45, wherein the composition is in a dry powder form.

47. The method of claim 46, wherein the bacterial culture comprises bacteria from the genus Bifidobacterium, Lactobacillus, or combinations thereof.

48. The method of claim 47, wherein the bacterial culture comprises B. infantis, B. breve, L. planatrum, L. reuteri, or combinations thereof.

49. The method of any one of claims 45-48, wherein the bacterial culture further comprises a preservative.

50. The method of any one of claims 45-49, wherein the weaning food comprises meat, fish, eggs, shellfish, fruits, vegetables, grains, nuts, seeds, dairy, or combinations thereof.

51. The method of claim 50, wherein the weaning food comprises barley, corn, hummus, lentils, oats, rice, wheat, avocado, beetroot, broccoli, squash, carrots, green beans, peas, potatoes, cassava, sweet potatoes, pumpkin, apples, bananas, plantains, blueberries, mango, peach, pear, papaya, watermelon, cheese, or combinations thereof.

52. The method of any one of claims 45-51, wherein the composition comprises bacterial culture and weaning food in a ratio of from 10⁶-10¹¹ CFU of bacterial culture to 100 g of weaning food.
